(19) United States
(12) Patent Application Publication
(10) Pub. No.: US 2016/0012853 A1
(43) Pub. Date: Jan. 14, 2016

(54) CLIP CREATION AND COLLABORATION

(71) Applicant: MUSEAMI, INC., Princeton, NJ (US)

(72) Inventors: J. Alexander Cabanilla, Bethesda, MD (US); Courtenay Cotton, New York, NY (US); Brendan Elliott, Hopewell, NJ (US); Ariel Melendez, Hillsborough, NJ (US); Jon Sheldrick, Brooklyn, NY (US); Robert D. Taub, Princeton, NJ (US); Michael Westendorf, East Windsor, NJ (US)

(21) Appl. No.: 14/794,743

(22) Filed: Jul. 8, 2015

Related U.S. Application Data
(60) Provisional application No. 62/022,587, filed on Jul. 9, 2014.

(51) Int. Cl. G11B 27/036; H04L 29/08; H04N 9/802; G11B 27/30; G11B 20/10; H04L 29/06; G11B 27/34

(52) U.S. Cl. CPC G11B 27/036; H04L 65/403; H04L 67/1097; H04L 65/601; H04L 69/04; G11B 27/34; G11B 27/30; G11B 20/10527; H04N 9/802; G11B 2020/10546

(57) ABSTRACT

A user performance that can include audio and video performance may be added to a multi-track clip. The combined user performance and clip can be stored at a local device as a composite performance, and effects processing may be applied to the user performance. The composite performance may be previewed and can be sent to a computer device over a computer network for sharing with other users.

### CROSS-REFERENCE TO RELATED APPLICATIONS

This application claims the benefit of priority from co-pending U.S. Provisional Patent Application No. 62/022,587 entitled “Clip Creation and Collaboration” to Robert Taub et al. filed Jul. 9, 2014. Priority of the filing date of Jul. 9, 2014 is hereby claimed, and the disclosure of the Provisional patent application is hereby incorporated by reference.

### BACKGROUND

Social media has helped to popularize sharing events and occurrence in the lives of individuals. Shared events may include travel, celebrations, parties, and the like, while the items shared may include pictures, messages, short clips comprising audio and video, movies, and the like. For many individuals, music and performing are important parts of life. Facilitating the sharing of music and performances, and of related events, would resonate with many persons.

For example, many persons would enjoy sharing their own musical contributions. Singing along to a song, with musical background, is the basis for many popular television shows, and many persons would like to duplicate a similar effort on their part, on a much less grand scale. Such sharing activities would be especially welcome if they could be integrated with personal mobile devices, such as smart phones and the like, in what might be characterized as a “musical selfie”. Sharing performances such as renditions of popular songs, unaccompanied singing (a capella), and acting, and the like, may also be desired. Greater convenience in such sharing, with opportunities to produce musical works that show the performer in a good light, would likely be well-received and would likely prove to be popular.

### SUMMARY

Disclosed are techniques for adding user-generated audio and/or video content to a multi-track clip simultaneously with the user listening to and viewing a playback of the clip. The clip may comprise, for example, a recorded, commercially-available, professional music performance. The clip may comprise a previously recorded performance, or even no performance at all (i.e., a clip comprising a blank track). The user's contributed performance may comprise singing along with the professional performance. Convenience is served by providing an application that can be executed on a local system comprising a user's mobile device, such as a smart telephone or tablet device. The application supports storing the combined user performance and clip at a local device as a composite performance. The stored, combined user performance and clip can then be used as a new multi-track composite clip to which, in turn, a user can add new audio and/or video content simultaneously with the user listening to and viewing a playback of the stored composite clip. The resulting combination of the new multi-track composite clip and new user contribution of audio and/or video content can similarly comprise the basis for yet another clip, to which a user can add new audio and/or video content, and so forth, repeatedly, if desired. In this way, multiple user performances can be combined with pre-recorded composite clips to produce a new composite clip.

A prior composite clip may comprise, for example, a recorded, commercially-available, professional music performance. A prior composite clip may comprise, for example, a user performance, such as a non-singing user performance, such that the new composite clip may appear as though the user is “lip-synching” to the preceding audio/video performance. In another example, multiple user performances may be cumulatively added to a composite clip either in parallel or serially. In this way, multiple user performances may be combined to produce combined performances that demonstrate harmony, or a capella renditions. Effects processing may also be applied to the user contribution. The effects processing may comprise audio effects, or video effects, or a combination of both audio and video effects. The clip may include separate tracks for an instrumental portion of the clip and a lead vocals portion of the clip. As noted above, the clip may include separate tracks for multiple user contributions. Such multi-track input facilitates a user listening to a recognizable professional performance, for example through earphones or headphones at a mobile device, while recording the user's performance, to replace the lead vocals portion of the professional performance with the recorded user performance. The effects processing can be used to improve the user's performance, increasing user satisfaction. The composite performance may be previewed and can be sent to a computer device over a computer network for sharing with other users.

The clips may be selected from a library of available clips. For example, the clip library may include music clips, movie clips, spoken word clips, video clips, and so forth. The effects processing may be selected from a library of available effects, to be applied to the user performance. The effects processing may provide adjustments such as reverberation, tone adjustment, pitch adjustment, and other audio and video effects, as described further below. The selection of clips and of effects processing by users can be tallied, and statistics relating to the selections and their popularity may be used to improve the relevance of available clips and effects processing. The recorded clips may include previously submitted composite performances, to layer additional user performances on top of other performances (vertical layering) or alongside other performances, before or after someone else's performance in time (horizontal layering). Viewing the previously submitted performances and applying effects processing, and previewing the results, can be performed remotely, at the user's device, so that no downloads of performances are necessary.

Other features and advantages of the present invention should be apparent from the following description of preferred embodiments that illustrate, by way of example, the principles of the invention.

### BRIEF DESCRIPTION OF THE DRAWINGS

FIG. 1 is a flow diagram of device operations for producing the composite performances and sharing discussed herein.

FIG. 2 is a block diagram showing multiple computing devices for the creation and collaboration application described herein.

FIG. 3 is a view of a mobile device on which an embodiment of the application is executing, showing a screen shot of a “Stream” menu page of the application that illustrates composite clips that have been uploaded.

FIG. 4 is a is a view of a mobile device on which an embodiment of the application is executing, showing a “Stream play” screen shot after one of the clips illustrated in FIG. 3 is selected.

FIG. 5 is a view of a mobile device on which an embodiment of the application is executing, showing a screen shot of a drop-down menu from the “Stream” page of the application illustrated in FIG. 3.

FIG. 6 is a view of a mobile device on which an embodiment of the application is executing, showing a screen shot of a “Sing” menu page of the application that illustrates tracks available for the user to select and sing with, creating a composite clip.

FIG. 7 is a view of a mobile device on which an embodiment of the application is executing, showing a screen shot of an options page after the user has selected the “Sing” option and a camera view option (rear-facing or forward facing) for one of the tracks from the “Sing” menu page of FIG. 6.

FIG. 8 is a view of a mobile device on which an embodiment of the application is executing, showing a screen shot of a Preview page of the application.

FIG. 9 is a view of a mobile device on which an embodiment of the application is executing, showing a screen shot after a Menu option has been selected from the FIG. 3 “Stream” page of the application.

FIG. 10 is a view of a mobile device on which an embodiment of the application is executing, showing a screen shot after a User Profile option has been selected from the FIG. 9 “User Login Name” menu of the application.

FIG. 11 is a view of a mobile device on which an embodiment of the application is executing, showing a screen shot after a Settings option has been selected from the FIG. 9 menu sidebar page of the application.

FIG. 12 is a view of a mobile device on which an embodiment of the application is executing, showing a screen shot of an Upload page that is automatically displayed after the selected clip has completed playing and recording has stopped.

FIG. 13 is a block diagram of the mobile device on which the application may execute, as illustrated in the screen shots of FIGS. 3-12.

FIG. 14 is a block diagram representation of a clip as received at the mobile device, showing the artist vocal track and instrumental/backing vocals track of the clip.

FIG. 15 is a block diagram representation of a clip as recorded by the user at the mobile device.

FIG. 16 is a view of a mobile device on which an embodiment of the application is executing, showing a screen shot of a Menu display of the application.

FIG. 17 is a view of a mobile device on which an embodiment of the application is executing, showing a screen shot of a “Browse” display of the application with “Freestyle” selection menu.

FIG. 18 is a view of a mobile device on which an embodiment of the application is executing, showing a screen shot of an “All” list display selected from the FIG. 17 menu.

FIG. 19 is a view of a mobile device on which an embodiment of the application is executing, showing a screen shot of an “A capella” selection from the FIG. 18 menu.

### DETAILED DESCRIPTION

The techniques disclosed herein enable a user to record a user performance with a computer device, such as a smart phone or portable music device or other mobile device. The user performance may broadly encompass user generated content such as singing along to background vocals and/or instrumental playing, dramatic acting, spoken word, lip synching, a capella renditions, physical activity, competition, and so forth. Combining such user performances with previously stored composite performances may be implemented through an application installed at the user's mobile device. With the installed application, the user can listen to a pre-recorded multi-track clip and can add user-generated audio and video performances to the clip, while listening and viewing playback of the clip. The clip may comprise, for example, a recorded, commercially-available, professional music performance. The user's added performance may comprise, for example, singing along with the professional performance. The installed application permits convenient adding and editing of the user's performance to the original clip, replacing a lead vocal or similar portion of the original clip with the user's performance and producing a composite clip.

The composite clip can be uploaded to a social media sharing site, for greater distribution of the user's composite clip. The clip typically will correspond to a recorded, commercially-available, professional artist performance, and the artist performance on which the clip is based may comprise, for example, a song or other complete artist performance that is commercially available, or may comprise a portion of the artist performance, such as a chorus or “hook” from a song. The clip for use with the application disclosed herein, however, departs from a typical commercially-available artist performance in that the clip for use with the application may include separate tracks for an instrumental portion of the clip and for a lead vocals portion of the clip. Alternatively, the clip may include separate tracks for an instrumental portion of the clip as well as a background vocals portion of the clip, and a lead vocals portion of the clip. A multi-track clip permits a user to listen to a recognizable professional performance, while recording the user's performance (i.e., content contribution) at the mobile device. For example, a user may optionally listen to a previously recorded performance, such as a commercially available recording, through earphones or headphones at the user mobile device. In this way, the user vocal performance may effectively replace the lead vocals portion of the professional performance for the composite clip, while leaving the remainder of the professional performance intact. As used herein, a “clip” will be understood to refer to a multi-track clip with different performances recorded in different tracks of the clip. For example, one track of the multi-track clip may comprise a professional artist contribution, which will be replaced with a user performance, and a separate track for background audio, vocals, and/or instrumental. As noted above, the separate tracks may comprise multiple user performances, to create harmony performances, instrumental works, lip synching, a capella renditions, and the like. As used herein, a “composite clip” will be understood to refer to a clip in which content such as a user's performance has been combined with a performance of the original clip. For example, depending on the configuration of the original clip, the composite clip may comprise a separate user performance vocal track, instrumental/background vocal track, and user video track.

The composite clip, comprising the combined user performance (audio and video) and the background/instrumental track, can be stored at the local user mobile device, and effects processing may be applied to the user performance track. The effects processing can be used to improve the user performance. In some embodiments, one or more of the effects processing is automatically applied, in real time, as the user performance is recorded. After the recording is completed, the composite performance may be previewed. Additional processing effects may be applied, or extracted, and observed in the preview operation. Once the user is satisfied with the composite performance, the composite clip with combined user performance, instrumental/backing vocals, and video segment, can be sent to a computer device over a computer network for sharing with other users.

The user interface presented for guiding the user through the performance and sharing provides a user experience that is convenient and enjoyable. A typical scenario involves a music server or other source of clips at a first computer device, and a user at a second computer device, such that the clips at the first computer device can be viewed while a user performance is recorded at the second device. In this way, the recorded user performance and the instrumental/background vocals of the original clip can be combined into a composite performance, for sharing with other users.

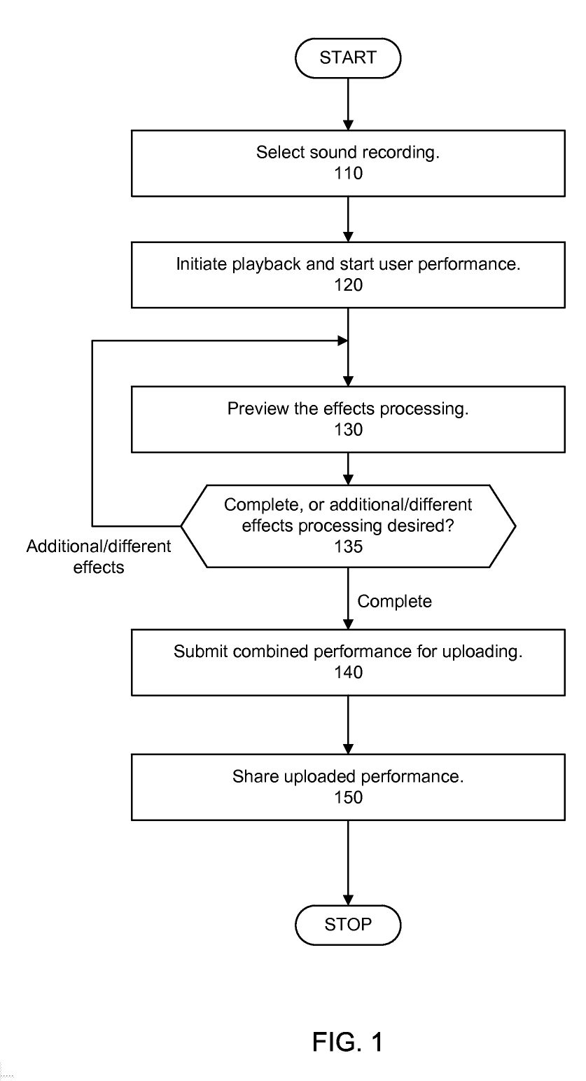

FIG. 1 is a flow diagram of device operations for producing the composite performances and sharing, using the installed application, as discussed herein. At the first operation, indicated by the box 110 of FIG. 1, a user selects a clip that is available from a first computer device, such as a music server or an online store for the clips described herein. The selected clip includes at least one track to which a user contribution of new content will be added, producing a composite clip that may be stored. The selected clip may comprise, for example, a vocal performance, or an instrumental performance, or no performance at all (i.e., a “blank” clip, as described further below). As noted above, the user will provide a user generated performance that is recorded, or stored, as the user provides the user generated performance in accompaniment to playback of the selected clip. If the selected clip is a music clip, for example, then the selected clip typically includes at least one track of an artist vocal performance and at least one track of an instrumental/background vocal performance, configured for playback by a music application. Other available clips may include other components comprising a primary performance that will be replaced by a user performance, and a background performance that will not be replaced. Typically, a selected music clip will include one track of artist vocal performance and one track of an instrumental/background vocal performance, and will include at least one synchronization indicator in each of the tracks, to which the tracks may be aligned for synchronized playback. To facilitate synchronization of the user's performance, the recording of the user's performance at the mobile device may be initiated at a time simultaneous with playback of the artist performance at the synchronization indicator.

Thus, the clip tracks, comprising the music data of the selected clip, may include a track of a lead vocal and a track of instrumental and/or other backup vocals. Additional data in the clip may include metadata for clip identification, clip format configuration, and the like, as well as music information such as song lyrics, tone information, pitch level and timing information, timbre information, and the like. The metadata may be stored in a header portion of one or more of the tracks, or the metadata may be stored in parallel with the music data of a track, or may be stored in a combination of the two. The clip may comprise, for example, an enhanced media file such as described in U.S. patent application Ser. No. 13/489,393 entitled “Enhanced Media Recordings and Playback” by Robert D. Taub, et al., filed Jun. 5, 2012. As described further below, the selected clip may comprise a previously submitted composite clip that includes a prior user performance and the selected clip. The previously submitted composite clip may comprise a clip without a lead vocals track.

At the next operation, indicated by the FIG. 1 box 120, the user initiates playback of the clip and simultaneously begins recording of the user performance. If desired, the application can provide a countdown of time remaining to the start of recording, to give the user sufficient time in which to be ready for the recording. The playback of the clip produces playback of the one or more tracks in the clip and is performed in response to a playback command of the application. The user will typically listen to the playback at an output terminal of the second computer device. For example, the user may listen to the playback at the headphone or earphone jack of the second computer device, which may comprise a smart phone, tablet computer, or music player. The user will listen to the playback with headphones or earphones, which will advantageously isolate the user from recording the previously recorded vocals along with the user vocals when recording the user performance, as described next.

The user performance to be recorded and combined with the previously recorded tracks of the selected clip, will typically involve both audio and video elements. For example, the user's computer device may comprise a smart phone with a rear-facing camera and a microphone. In this way, the user can record video of the user's performance and audio of the user's performance, at the same time. The selected clip may include instrumental/background vocals of a professional and/or commercially available recording. If the user's computer device has a forward-facing camera and a rear-facing camera, then the user has the option of recording video of the performance that is viewed through the rear-facing camera, which is the usual scenario, or recording the performance that is viewed through the forward-facing camera. When using headphone or earphones, the user will be able to hear the professional performance lead vocals of the clip, but the user's recorded performance will be without the professional lead vocals, effectively replacing the professional lead vocals with the user's performance. The recording of the user's performance is initiated at the user's second computer device in response to a store command or record command or similar command of the application, so recording will not begin until the user is ready.

In the next operation, at the box 130, the user is able to select and preview the effects processing. The application will cause the device, in response to a preview command, to generate a combined performance comprising the recorded user performance and at least one of the one or more tracks of music data. As noted above, the clip tracks of music data that will be recorded and stored at the second device will typically include all the tracks of the clip, except for the lead vocal track of the clip. As noted above, the clip can be obtained with the lead vocal comprising one of the tracks, with other instrumentation and background vocals on one or more other tracks. A variety of effects processing may be employed to the composite clip to produce a new composite clip, which may be stored. Available to the user are audio effects, or video effects, or a combination of both. The effects may comprise, for example, effects such as reverberation, echo, gloss, pitch, harmony, helium, and melting or dissolving effects. Many additional effects may be implemented to modify the tracks of the clip, effects such as muting a backing track, flanger, ring modulation, stereo-panning automation, video filters (e.g., spotlight, sepia, black & white, posterizing, and so forth), telephone audio processing (e.g., reduction of bandwidth permitted for a clip), “bit crusher” (i.e., reduction of dynamic range), stutter, wah wah, tape noise and recording hiss, crowd noise, chorus, shouts, “helium balloon” effects, multi-band compression, tempo-sync effects (e.g., tremolo, auto-pan, filter-sweep), amplification overdrive and distortion, bullhorn, radio, data-driven vocal layering, “ping pong” delay, duets, mashup of tracks and sources, arpeggiator, reverse, format “boost” for a vocalist, and vocoder (e.g., Imogen Heap, “Hide & Seek”). Additional effects available to the user may include converting from color images to black & white images, resolution modification (both higher and lower), clips comprising images and video from a pre-stored library of images and video, multiple screens such as tiles in a window that are presented sequentially or simultaneously, lighting changes, and the like.

As part of the preview processing, the user may audition the recorded user performance for satisfaction, and also may select one or more effects processing to be applied to the user performance. Such operations are indicated in FIG. 1 at the decision box 135. The application may include a default effects processing that may be applied to the user performance. For example, most persons find that a modest amount of reverberation added to a user performance has a pleasing effect, so the default effects processing may comprise such modest, subtle reverberation processing. The effects processing may comprise audio adjustments, or video effects, or a combination of the two. The effects processing may comprise, for example, a reverberation effect, tone adjustment, pitch adjustment, or other audio adjustment to the user performance. The effects processing may also comprise, or in place of or in addition to audio effects may comprise, a video adjustment to the user performance, such as superposition, black & white or color conversions, brightness, contrast, saturation, and the like. With respect to the default effects processing, a relatively subtle reverberation effect may improve the subjective sound of a performer's voice, and therefore, if desired, a relatively modest application of a reverberation effect may be applied to the user's performance. Other effects may be applied as a default operation, as desired.

As noted above, at the box 135, after the user finishes the performance and completes review of the composite clip, the user may audition the recorded user performance for satisfaction, and also may select one or more effects processing to be applied to the user performance. If the user is not satisfied with the user's performance upon viewing the combined tracks from the preview operation, then the user may decide to apply different effects processing, remove effects processing, or make any other adjustments, as desired. A decision to apply additional/different effects processing, an affirmative outcome at the box 135, will result in the application returning to the preview operation at the box 130, after recording and/or applying the effects processing to the recorded user performance.

After the user is satisfied with the user performance, as observed in the preview operation, the user can indicate completion of effects processing, and at the “complete” decision outcome at the decision box 135, the application can store the combined performance (i.e., the composite clip) at the second computer device (i.e., the user mobile computer device). The storing of the composite performance at the user device is typically performed in response to a store command at the second computer device. The combined performance comprises the user performance, audio and video, the backing vocals, any instrumentation, and the like. The combined performance is stored as a single track of audio, with left and right audio channels, and combined with the user's video track, with the effects processing applied. That is, the application responds to the store command by applying the effects processing, combining the processed user track of audio or audio-video, and saving the combined performance to memory of the second computing device. Thus, the combined performance is suitable for uploading to sharing Web sites such as “YouTube” and the like.

The enhanced features disclosed herein, such as audio processing of the user generated performance, may be implemented using enhanced media files, such as described in the aforementioned U.S. patent application Ser. No. 13/489,393 entitled “Enhanced Media Recordings and Playback” by Robert D. Taub, et al., filed Jun. 5, 2012. The processing of the file to produce the enhanced features may be achieved by an enhanced media file application that recognizes the requested effects and is configured to implement the requested effects. The enhanced media file may comprise, for example, album tracks or movie chapters comprising tracks or chapters of a conventional audio or video (multimedia) work, supplemented with enhanced features such as those disclosed herein, including recorded user input, real-time vocal effects, and the like. That is, the conventional audio or video work may be a commercially available recording that is separately available, whereas the present disclosure describes an enhanced version of the commercially available recording, having all the material available on the commercially available recording, and also having the enhanced features disclosed herein.

The enhanced media file that is stored by the system typically comprises an album track that is produced from a number of previously recorded files that define audio tracks or stems. For a conventional audio file, a two-channel left and right track (L/R stereo) file is created from source audio files, from which a master stereo file can be created. This stereo master may comprise, for example, a conventional stereo music file that is commercially available to listeners, such as for programming recorded onto physical media such as CD, DVD, BD recordings or vinyl records, or such as electronic format programming available through online retail sales such as the Web site of Amazon.com, Inc. of Seattle, Wash., USA or such as the “iTunes Music Store” of Apple Inc.

Any number of tracks using various channel layouts according to the file format being used can be encoded into the stereo master. The enhanced file format may be designated by a file suffix that indicates type. For example, the enhanced file format may comprise an “m4a” file format as described in the aforementioned U.S. patent application Ser. No. 13/489,393 entitled “Enhanced Media Recordings and Playback” by Robert D. Taub, et al., filed Jun. 5, 2012. The “m4a” file type may include channel layouts that comprise standard audio channel configurations, multichannel joint-surround encodings, and sequential encodings. The tracks to be encoded may be provided by the user, or by recording artists, media distributors, record labels, sponsors, and the like. Most recorded works are sourced from multiple tracks such as vocal and music (instrumental) tracks. The multiple tracks are mixed down during the mastering process and typically a final two-track (stereo) work is produced. The final work according to the file format can sometimes have a multiple number of tracks that are automatically mixed down by the playback application from the multiple tracks into two-channel (stereo) form for presentation to the listener. For example, the “iOS” platform operating system for mobile devices from Apple Inc. does not currently allow for direct access to individual tracks, but rather utilizes mixed-down stereo samples. Thus, it renders the various channel layouts available to m4a files as useless in the endeavor described herein. As a consequence, the conventional master stereo tracks are placed in their typical position in the enhanced media file as would be expected by a conventional player application for a conventional media file. Additional information, such as m4a metadata tags, are also placed in their typical position in the enhanced media file as would be expected by a conventional player application. This arrangement supports backwards compatibility of the enhanced media file with conventional playback devices.

Thus, the enhanced media file described herein is produced starting with a collection of audio files, a two-channel L/R data file, and a master m4a file that are used for producing the conventional album track. As noted, the tracks of the master m4a file are placed in the enhanced media file in locations corresponding to their typical position in the corresponding conventional commercially available album track.

All of the additional multimedia tracks and feature data that provide the enhanced effects features disclosed herein are appended to the user-data section of the m4a enhanced media file. Because of the additional data for the enhanced features, the enhanced media file is a larger file than would otherwise be needed for the data of a conventional file. The increased file size, however, is necessary for providing the enhanced features, and the additional data is not of a size that creates any significant problem or difficulty for processing by the device. It should be noted that the enhanced features as described herein could also be generated as described even with an operating system that grants full access to individual tracks of songs and movie chapters.

At the next box 140 of device operations for producing the composite performances and sharing using the installed application, the user selects the submit display button. The submit button causes the application to send the combined performance over the computer network to another computing device, such as a device at a sharing site or social media site. At approximately the same time, the application causes the unprocessed user vocal track and the unprocessed user video track to be sent to the application developer's site, along with metadata for song and configuration identification. Saving such unprocessed, or “raw” elements, enables efficient storage of user submissions and enables relatively easy recapture or re-creation of the user's submission, by applying the effects processing to the raw audio and video files.

When users submit their performances, the metadata indicating the effects processing that was applied can be used to collect data that identifies effects processes selected from a plurality of computing devices from which the effects processes are applied to the user performances. In a similar way, data can be collected that identifies clips selected from a plurality of computing devices from which clips are selected.

The recorded clips may include previously submitted composite performances, which may be made available for public viewing and selection for recording. The previously submitted performances, upon selection, may be used to layer additional user performances on top of other performances (vertical layering) or alongside other performances, before or after in time (horizontal layering). Viewing the previously submitted performances and applying effects processing, and previewing the results, can be performed remotely, so that no downloads of performances are necessary. That is, the previously submitted user performances may be viewed, but no copies will be sent to a requesting user, thus avoiding privacy and property rights issues.

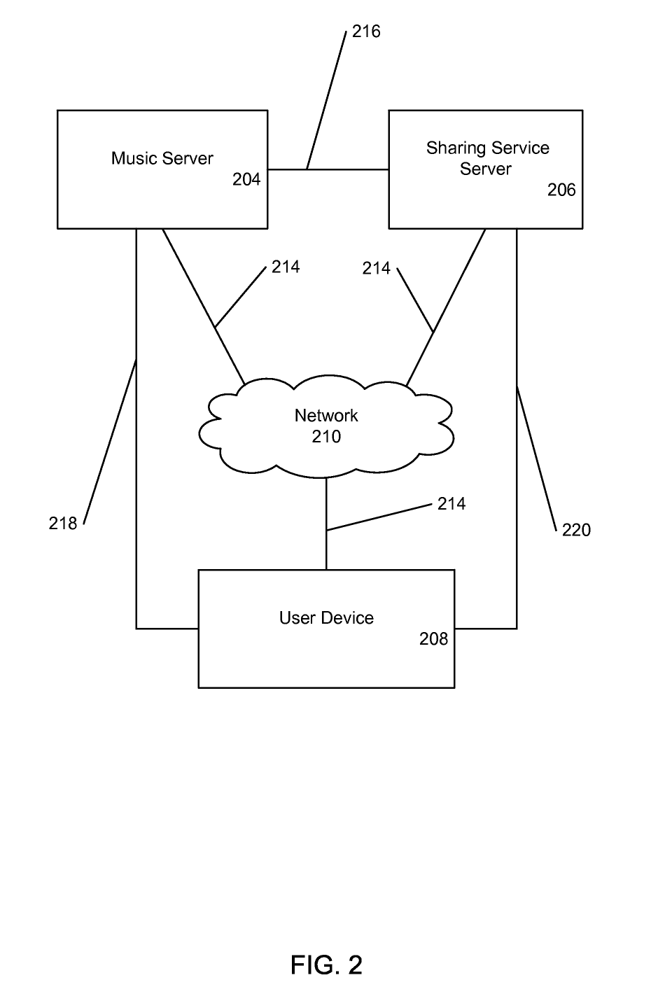

FIG. 2 is a block diagram showing multiple computing devices for the music creation and collaboration application described herein. A server 204, also referred to as the first computing device, is a source of clips as described herein. In the described embodiment, the server 204 is suitably configured to provide music-related clips. The upload of a composite clip results in the composite clip being transmitted to a server 206 of a sharing service. The sharing service may comprise a great many different social media and posting services, such as “YouTube”, “Facebook”, “Instagram”, and the like. The viewing of clips with artist performances, the recording of user performances, and the user operations and corresponding processing described above in conjunction with FIG. 1, take place in the user mobile computing device 208. The transfer of data between the computing devices 204, 206, 208 may go through network storage or other network connections, represented in FIG. 2 as the network 210. The computing devices 204, 206, 208 can communicate with each other over network connections 214 through the network 210. Alternatively, any two of the devices 204 206, 208 may communicate directly, such as through hard-wired connections, such as the direct connection 216 between the music server 204 and sharing service 206, between the music server 204 and user mobile device 208, and between the sharing service 206 and user mobile device 208.

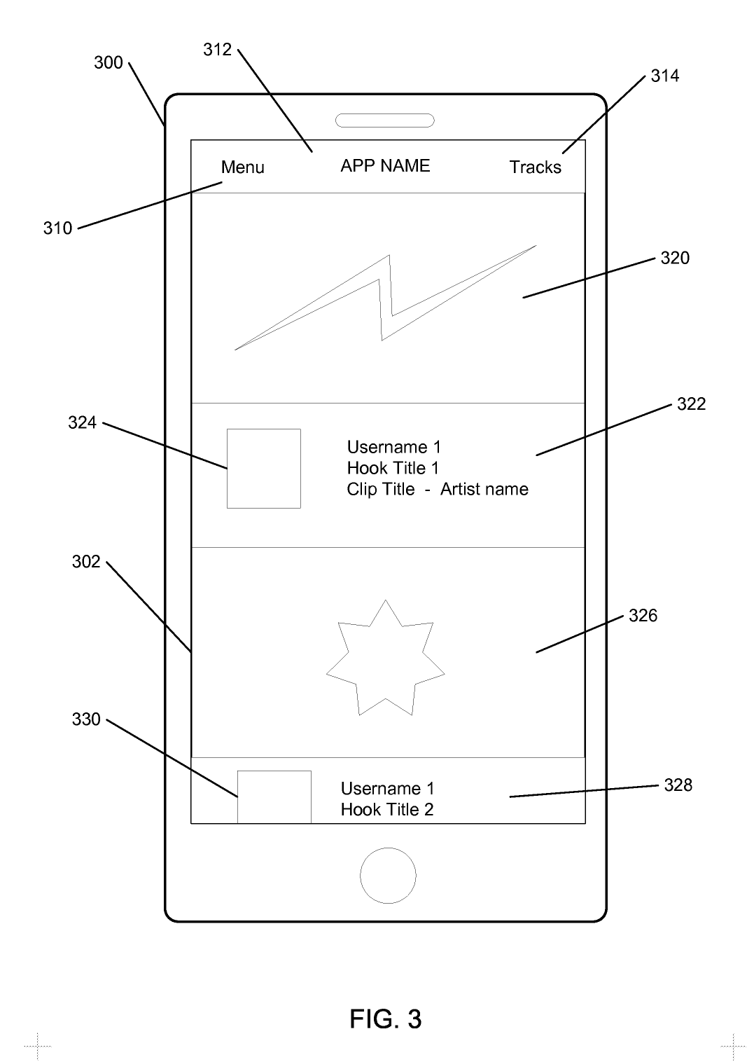

FIG. 3 is a view of a mobile computer device 300 on which the application described herein is executing, showing a screen shot of a “Stream” menu page of the application that illustrates composite clips that have been uploaded. The display 302 of the user mobile device 300 is a touchscreen display, as is well-known in the art. A variety of display pages of the application are available for viewing, as described further below. FIG. 3 shows a “Stream” page, which is a default page for the application to show upon launch. Across the top of the Stream page is a menu bar showing a Menu option 310, a Tracks option 312, and an APP NAME option 314. Unless otherwise indicated, “options” as described herein represent links in the display page that, when selected by tapping or touching, will cause the application to carry out or initiate processing for the selected option. The menu bar items of the Stream page remain fixed on the Stream page, while beneath the menu bar in the Stream page is a scrolling list of available composite uploaded tracks that are available for streaming.

FIG. 3 shows a sample video frame or other indicia of a first submitted composite video 320 and, beneath it in the Stream page, a clip listing 322 that shows the user name (Username 1), title of the submitted clip (Hook Title 1), title of the original clip (Clip Title), and name of the clip artist (Artist name). Adjacent the clip listing is an icon or thumbnail image 324 that represents the user (User name 1).

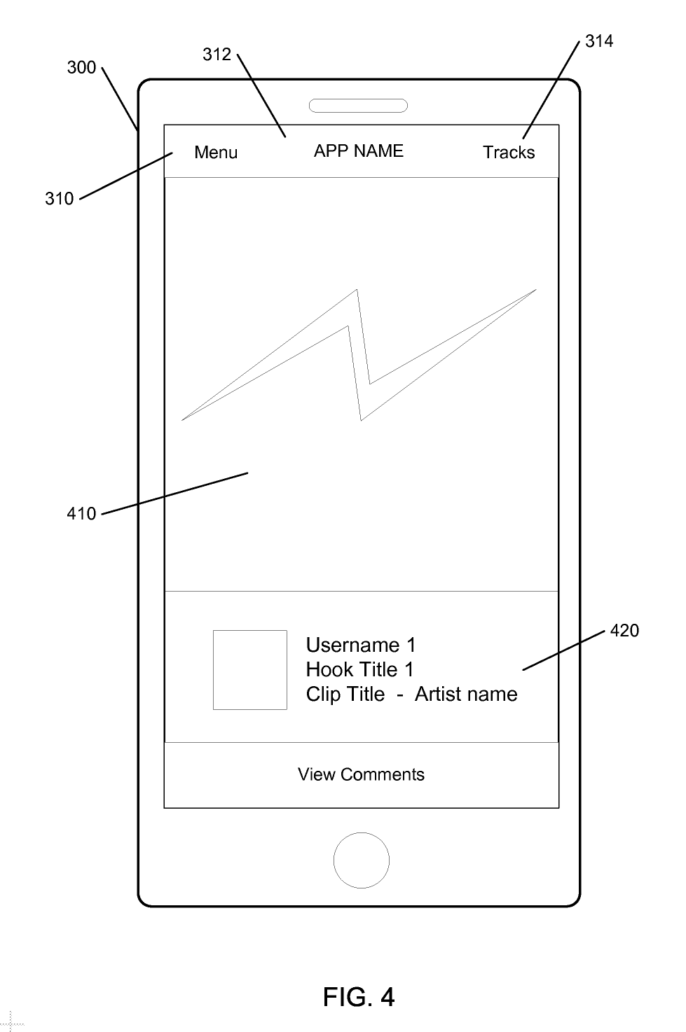

FIG. 4 is a is a view of a mobile device 300 on which an embodiment of the application is executing, showing a “Stream play” screen shot after one of the clips illustrated in FIG. 3 is selected. More particularly, FIG. 4 is produced in response to the user selecting the first composite clip. Thus, FIG. 4 shows the clip video image window 410, enlarged as compared to the image size 322 in the Stream page, showing the clip listing window 420, corresponding to the selected clip listing 322 from FIG. 3 in a window enlarged as compared to the corresponding FIG. 3 image. The population of application users may post comments to composite clips, and FIG. 4 includes a comment display portion of the page; additional comments may be viewed by scrolling the Stream display page using the touchscreen, as is well-known in the art.

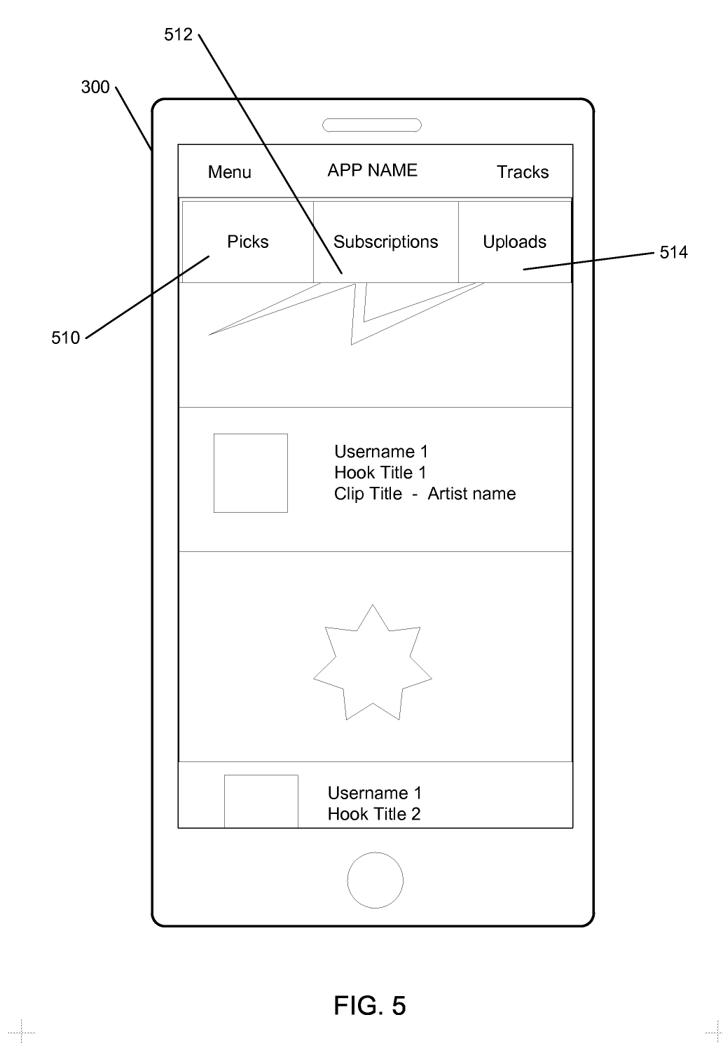

FIG. 5 is a view of a mobile device 300 on which an embodiment of the application is executing, showing a screen shot of a drop-down menu from the “Stream” page of the application illustrated in FIG. 3. The FIG. 5 display is produced when a user selects, by tapping, the APP NAME link 312. In response to the selection, the application causes the FIG. 5 drop-down menu to appear. The FIG. 5 drop-down menu shows display buttons for recommended or suggested Picks 510, Subscriptions 512 of the user, and Uploads 514 of the user.

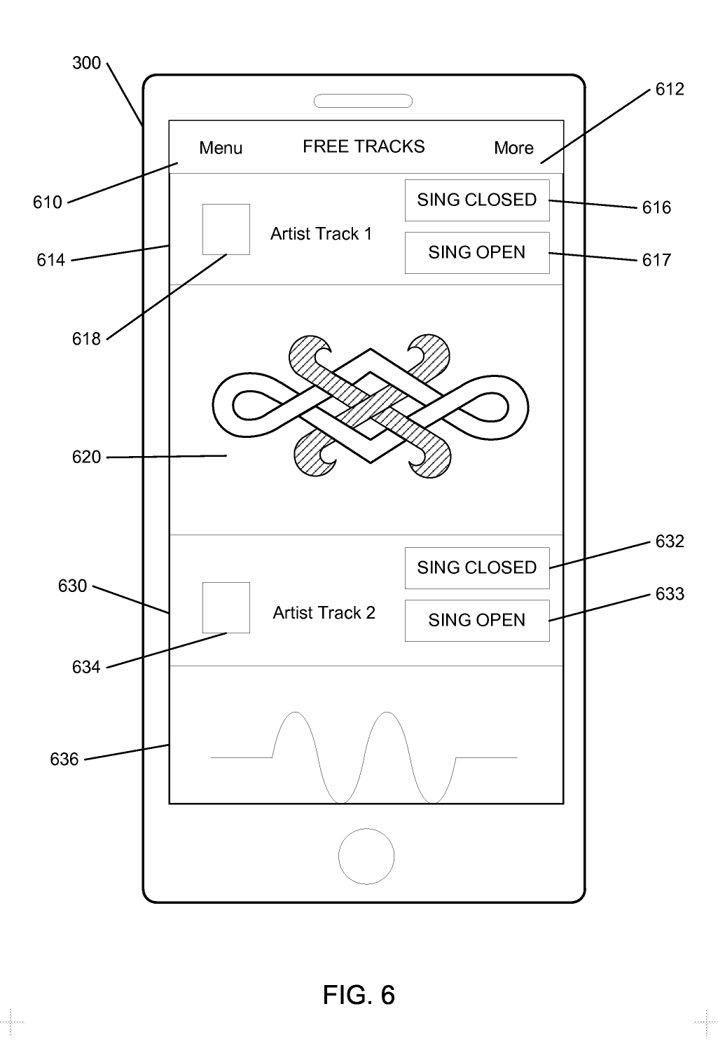

FIG. 6 is a view of a mobile device 300 on which an embodiment of the application is executing, showing a screen shot of a “Sing” menu page of the application that illustrates clips (also called “tracks”) available for the user to select and sing with, for creating a composite clip. The Sing page may be selected from a menu display, as initiated by selecting “Menu” 610 from the menu bar and as described further below. In the FIG. 6 Sing page, both free tracks and tracks for purchase may be listed. Switching between free tracks and purchase tracks may be initiated by selecting the “More” button 612 in the menu bar. FIG. 6 shows a first available track or clip listing 614, indicated as Artist Track 1. The track is selectable by tapping a “Sing” display button, either a “Sing Closed” button 616 or a “Sing Open” button 617, for user singing with listening devices such as headphones or earbuds, or for user singing without listening devices, respectively. Tapping the SING CLOSED button 616 initiates playback of the corresponding clip such that playback of the clip is directed to headphones or earbuds worn by the user. Tapping the SING OPEN button 617 initiates playback of the corresponding clip such that playback of the clip is directed to audio loudspeakers of the mobile device. Alternatively, playback to the mobile device speakers or to listening devices may be implemented according to default operation of the mobile device, in which case only a single SING button would be needed for the user interface. For example, many mobile devices direct playback to device loudspeakers by default, and change operation to direct the playback to listening devices (e.g., earbuds) upon connection of such listening devices to the mobile device. An icon or thumbnail representation 618 of the artist may be included, and an icon or image or other representation 620 of the clip or track is located below the first track listing 614. FIG. 6 shows a second available track or clip listing 630 indicated as Artist Track 2, selectable by tapping one of the SING display buttons 632, 633 as noted above. Thus, tapping the SING CLOSED button 632 initiates playback of the corresponding clip such that playback of the clip is directed to headphones or earbuds worn by the user, and tapping the SING OPEN button 633 initiates playback of the corresponding clip such that playback of the clip is directed to audio loudspeakers of the mobile device. An icon or thumbnail representation 634 of the artist may be included, and an icon or image or other representation 636 of the clip or track is located below the second track listing 630. Only a portion of the second listing 636 is visible in FIG. 6, due to the touchscreen display. Scrolling permits the user to view additional clip listings, as is well-known in the art.

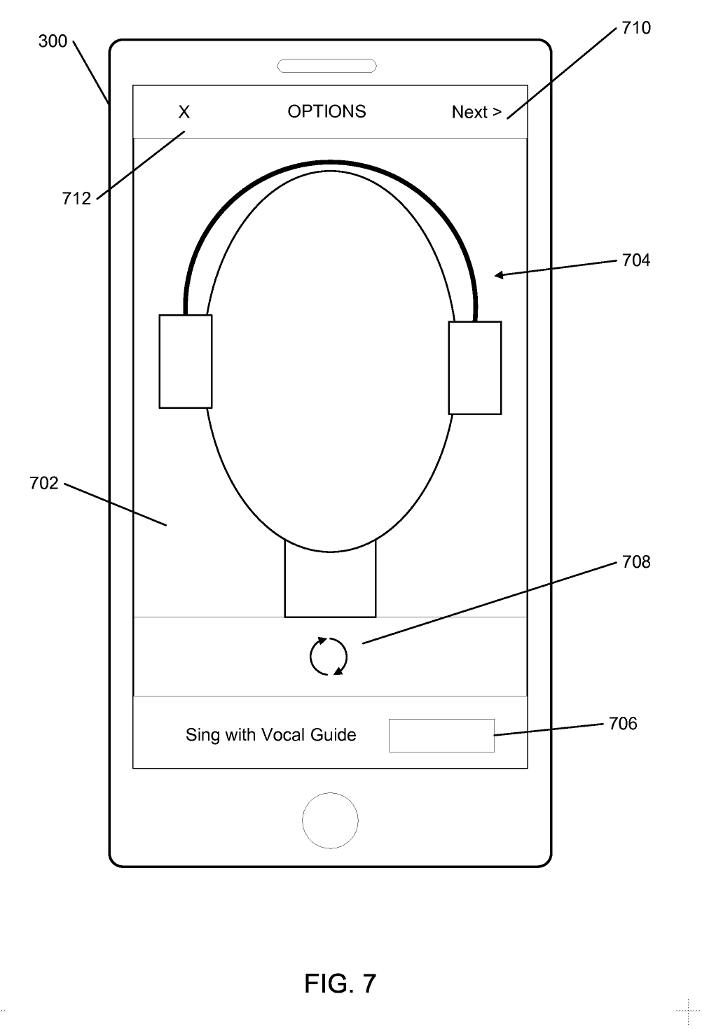

FIG. 7 is a view of a mobile device 300 on which an embodiment of the application is executing, showing a screen shot of an Options page of the application, after the user has selected the “SING” option for one of the tracks from the “Sing” menu page of FIG. 6. Selecting one of the FIG. 6 “SING” display 616, 632 buttons causes the application to respond by producing the FIG. 7 display, in which a viewing window 702 shows the image from a camera of the user mobile device. The image shown in the window shows the user 704, wearing headphones. The user has a selectable option 706 to show song lyrics with a vocal guide that assists the user with pacing for singing along. The display page of FIG. 7 also includes a camera display switch 708 that permits the user to switch between a rear-facing camera of the mobile device and a forward-facing camera of the mobile device. Thus, the user's performance may comprise a performance recorded with the rear-facing camera (most likely the user performing) or the user's performance may comprise a performance recorded with the forward-facing camera (most likely others performing). The recording of the user's performance is initiated by the user selecting the Next button 710. The viewing and recording operation may be halted by the user selecting the “X” button 712.

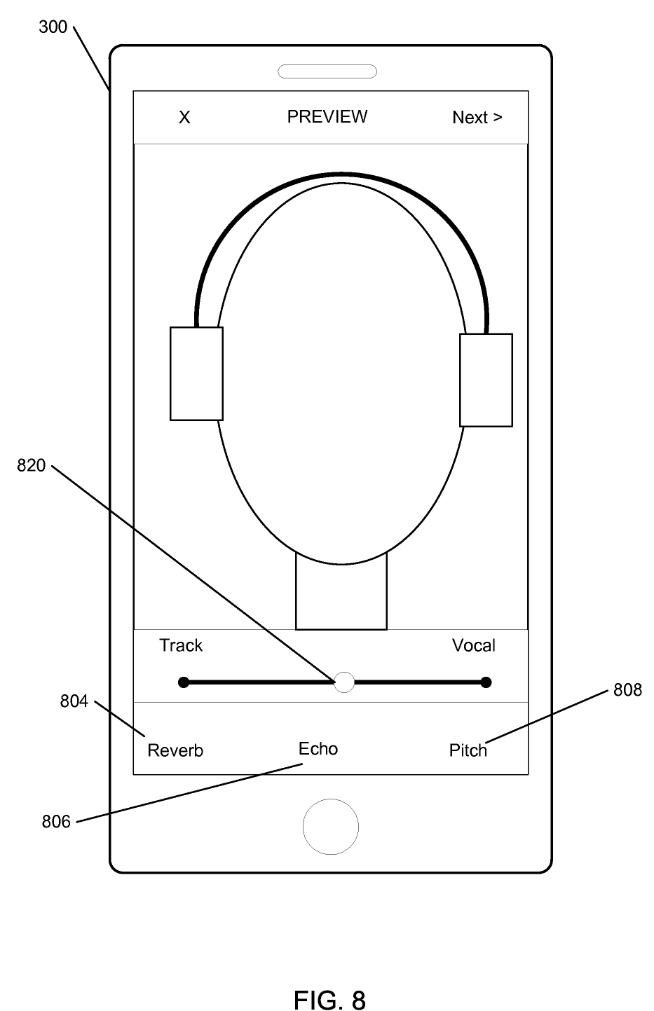

FIG. 8 is a view of a mobile device 300 on which an embodiment of the application is executing, showing a screen shot of a Preview page of the application. The recording is halted by the user selecting the “X” button, or is automatically halted when the clip finishes playback. The user may select effects processing from among alternatives in a display window, such as the illustrated effects options of Reverberation 804, Echo 806, and Pitch 808. The relative volume level of the instrumental/backing vocal track and of the user vocal may be adjusted 100% instrumental or 100% user vocal, or any proportion in between, by moving a sliding display button 820.

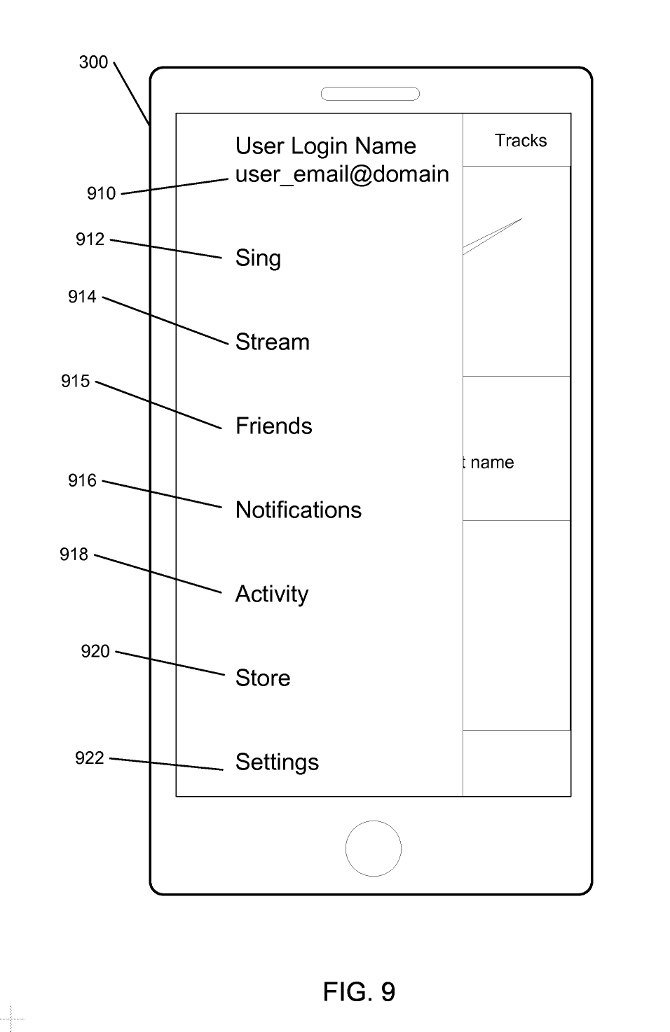

FIG. 9 is a view of a mobile device 300 on which an embodiment of the application is executing, showing a screen shot after a Menu option has been selected from the top left corner of the FIG. 3 “Stream” page. More particularly, the Menu options show the User Login Name 910, Sing page 912, Stream page 914, Friends 915 page, Notifications page 916, Activity 918, Store 920, and Settings 922.

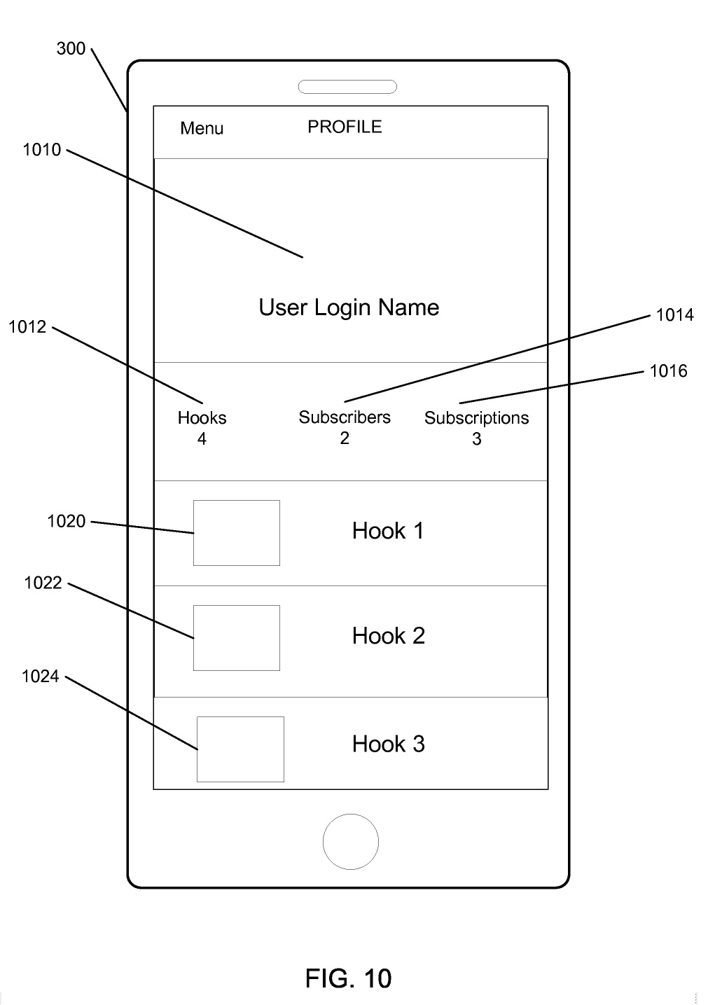

FIG. 10 is a view of a mobile device 300 on which an embodiment of the application is executing, showing a screen shot after a User Profile option has been selected from the FIG. 9 “User Login Name” menu of the application. The Settings option shows the User Login Name 1010, directly above information showing the number of user composite clips (hooks) 1012 uploaded thus far, number of subscribers to the user's clips 1014, and the number of subscriptions 1016 by the user. The user's uploaded clips 1020, 1022, 1024 are listed below, with a thumbnail and selectable clip title, shown as Hook 1, Hook 2, and Hook 3, respectively. Any of the listed clips may be selected for viewing by selecting the corresponding thumbnail/title

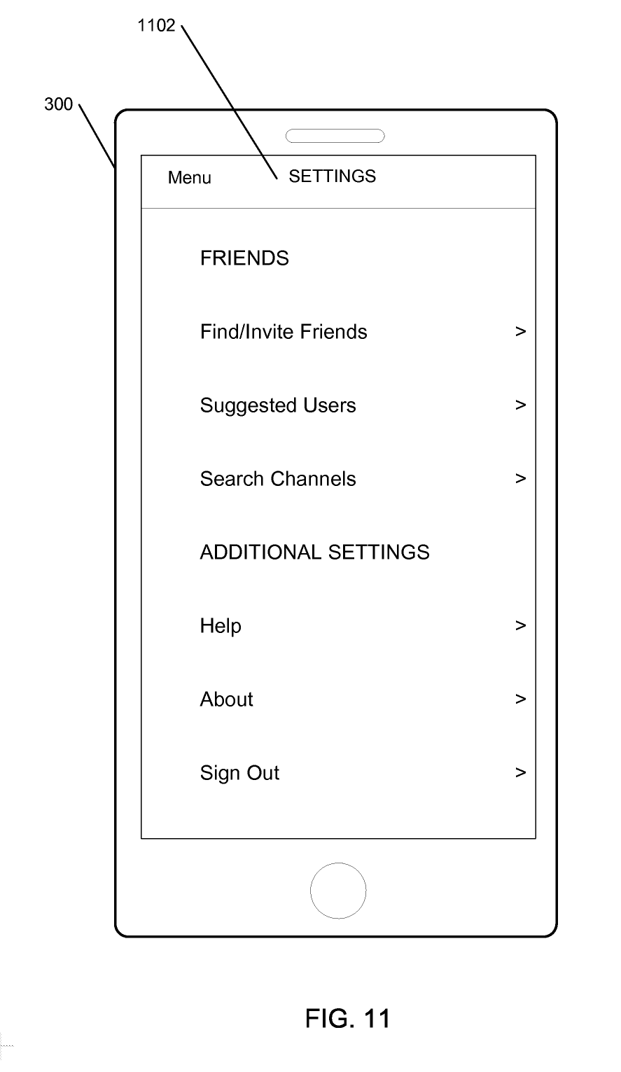

FIG. 11 is a view of a mobile device 300 on which an embodiment of the application is executing, showing a screen shot after a Settings option has been selected from the FIG. 9 menu sidebar page of the application. The Settings page 1102 shows a group of selectable page links grouped under “Friends”, comprising “Find/Invite Friends”, “Suggested Users”, and “Search Channels”. FIG. 11 also shows a group of selectable page links grouped under “Additional Settings”, comprising “Help”, “About”, and “Sign Out”.

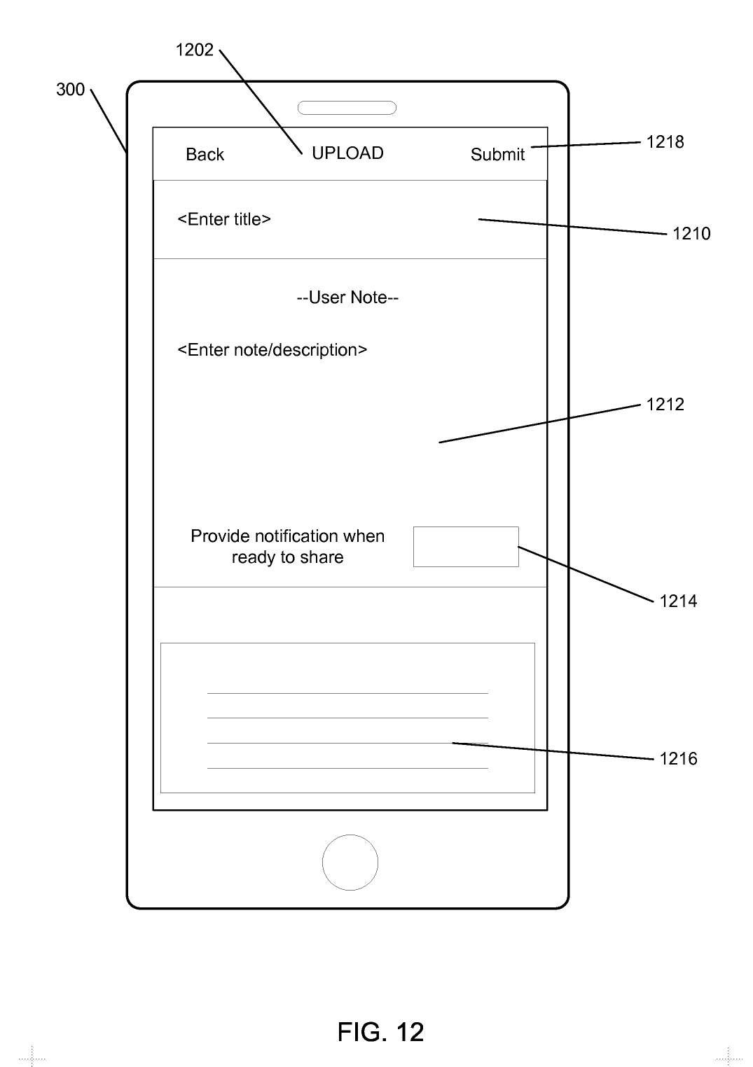

FIG. 12 is a view of a mobile device 300 on which an embodiment of the application is executing, showing a screen shot of an Upload page 1202 that is automatically displayed after the selected clip has completed playing and recording has stopped. The Upload page includes a title window area 1210 for the composite clip title. Beneath the title window 1210 is a User Note window area 1212 and a display switch 1214 for the user to indicate if the user wants to receive a notification after the composite clip has finished uploading. A virtual keyboard 1216 is suitable for the user to input text to comprise the title 1210 and the notes 1212. The uploading operation is initiated by selecting a “Submit” display button 1218 in the Upload page.

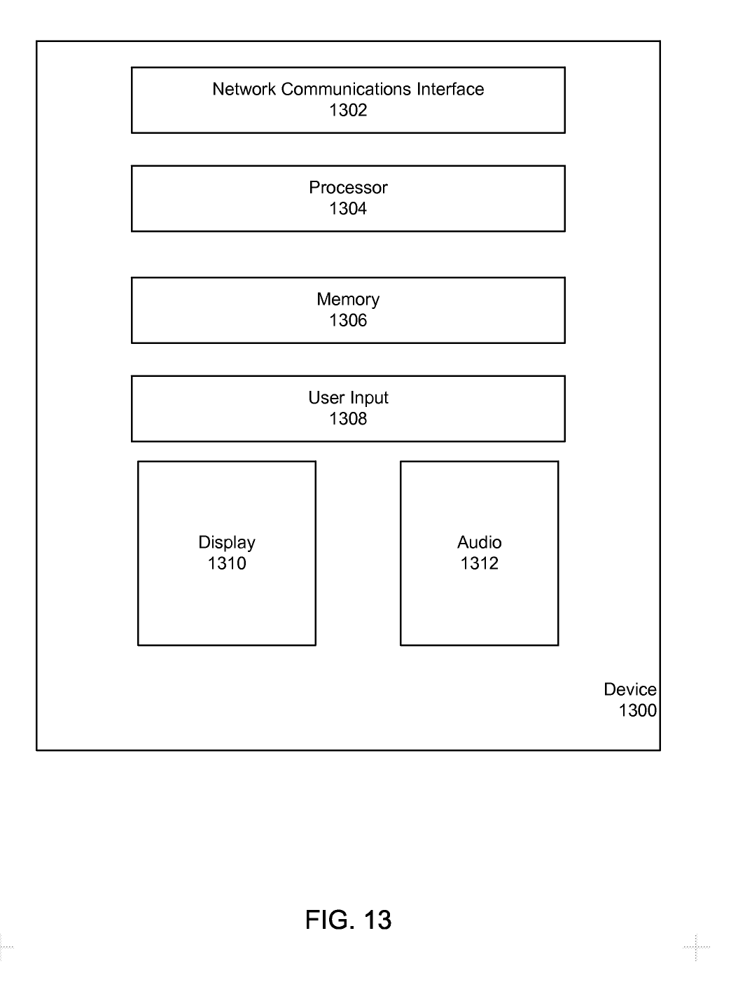

FIG. 13 is a block diagram of a computer device 1300. The computer device 1300 is suitable for installing the creation and collaboration application disclosed herein, such as the user mobile device illustrated in FIGS. 2-12 and described in the corresponding specification. The computer device 1300 may also be suitable for performing the operations ascribed to the server 204 and the computer device 206 for the sharing service of FIG. 2. For example, the application may be installed on the device 1300 for support of the user performance features for processing of the clips and/or previously submitted performances. Thus, the computer device 1300 may comprise a mobile platform computer device such as a smartphone, laptop, or tablet computer device or may comprise a desktop computer device, or one of a variety of computer devices with similar capabilities. The construction of the computer device 1300 is suitable for providing the music-related operations of the music server 204 and sharing service computer 206, and also is suitable for performing the additional extra-musical or non-musical operations noted for the devices 204, 206.

The host device 1300 includes a network communications interface 1302 through which the device communicates with a network and/or other users. For example, the interface 1302 may comprise a component for communication over “WiFi” networks, cellular telephone networks, the “Bluetooth” protocol, and the like. A processor 1304 controls operations of the host device. The processor comprises computer processing circuitry and is typically implemented as one or more integrated circuit chips and associated components. The device includes a memory 1306, into which the device operating system, enhanced media file application, user data, and machine-executable program instructions can be stored for execution by the processor. The memory can include firmware, random access memory (RAM), and storage media. A user input component 1308 is the mechanism through which a user can provide controls and data. The user input component can comprise, for example, a touchscreen, a keyboard or numeric pad, vocal input interface, or other input mechanism for providing user control and data input to operate the creation and collaboration application described herein. A display 1310 provides visual (graphic) output display and an audio component 1312 provides audible output for the device 1300. It should be understood that a wide variety of devices are suitable for execution of the creation and collaboration application described herein.

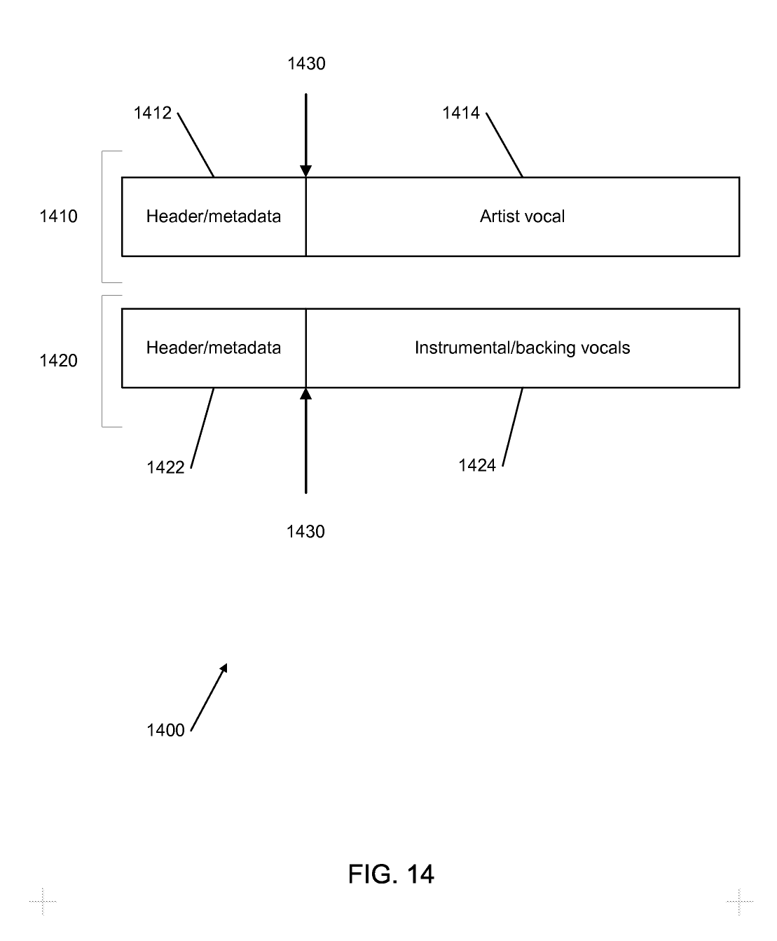

FIG. 14 is a block diagram representation of a clip 1400 as received at the mobile device, showing the artist vocal track and instrumental/backing vocals track of the clip. The clip 1400 includes at least two types of music data on separate tracks, an artist vocal track 1410 and an instrumental/backing vocals track 1420. The artist vocal track 1410 includes a header portion 1412 and a music data portion 1414. The instrumental/backing vocals 1420 track includes a header portion 1422 and an instrumental/backing vocals portion 1424. The shared header/data boundary 1430 of each track comprises a synchronization mark that indicates the beginning of the music data in each respective track.

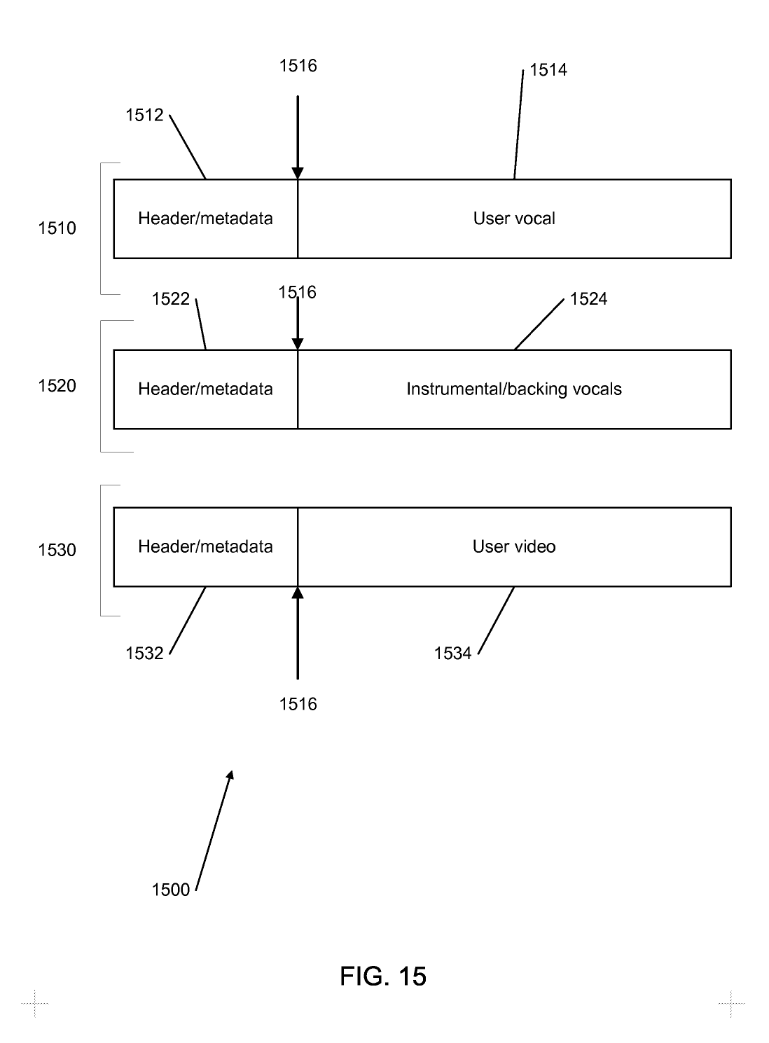

FIG. 15 is a block diagram representation of a composite clip as recorded by the user at the mobile device. The clip 1500 is produced by the user mobile device 208 (FIG. 2) in response to the “Submit” display button 1218 (FIG. 12). FIG. 15 shows that the composite clip includes three types of music data on separate tracks, comprising a user vocal track 1510, an instrumental/backing vocals track 1520, and a user video track 1530. The user vocal track 1510 includes a header portion 1512 and a music data portion 1514. The shared header/data boundary 1516 comprises a synchronization mark that indicates the beginning of the music data. The instrumental/backing vocals 1520 track includes a header portion 1522 and an instrumental/backing vocals portion 1524. The user video track 1530 includes a header portion 1522 and an instrumental/backing vocals portion 1524. The shared header/data boundary 1516 of each track 1510, 1520, 1530 comprises a synchronization mark that indicates the beginning of the music data in each respective track. Upon pressing the “Submit” display button, the user vocal track 1510 and user video track 1530 are uploaded to the music server 204, whereas the three tracks 1510, 1520, 1530 are combined as needed for the destination sharing service server 216. Typically, sharing services require files submitted for sharing to comprise a multimedia type of file format, so that all three separate tracks 1510, 1520, 1530 are combined into a single multimedia file, such as multimedia files having a filename suffix such as MOV, MP4, MP3, M4A, and the like.

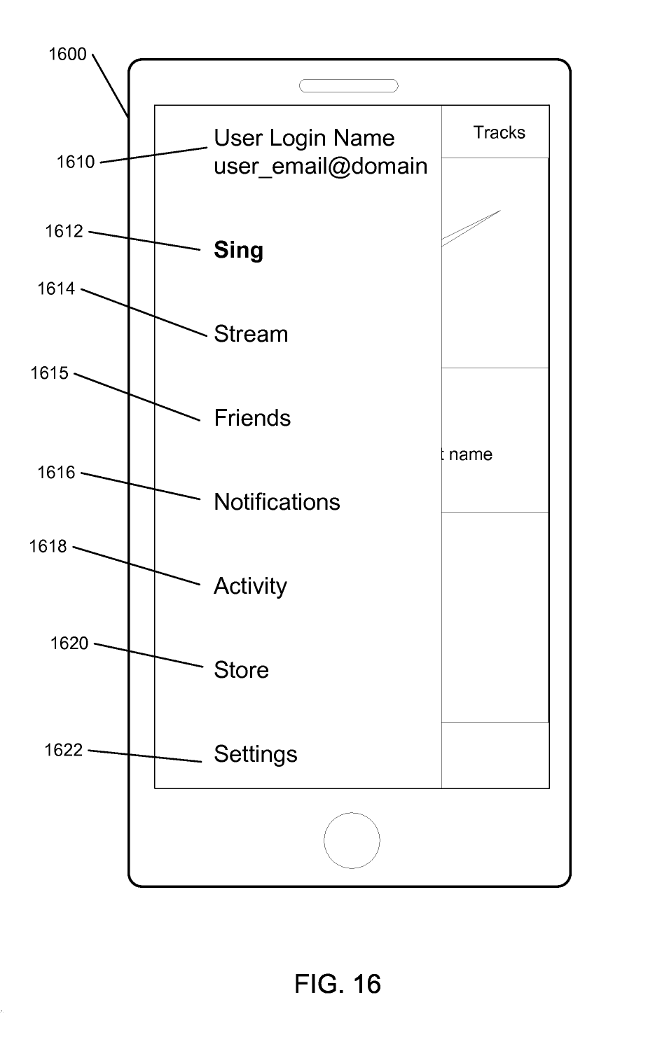

FIG. 16 is a view of a mobile device 1600 on which an embodiment of the application is executing, showing a screen shot of a Menu display of the application. The Menu display is similar to that shown in FIG. 9. FIG. 16 shows the User Login Name 1610 and items to select the Sing page 1612, Stream page 1614, Friends page 1615, Notifications page 1616, Activity 1618, Store 1620, and Settings 1622. The FIG. 16 Menu display may be initiated in response to selection of a menu icon (e.g., see FIG. 3 and related description). Selecting any one of the available features 1612, 1614, 1615, 1616, 1618, 1620, 1622 will initiate processing to provide the corresponding feature, which will be familiar to those skilled in the art in view of this disclosure. In FIG. 16, the Sing item 1612 is highlighted in boldface to indicate that it has been selected.

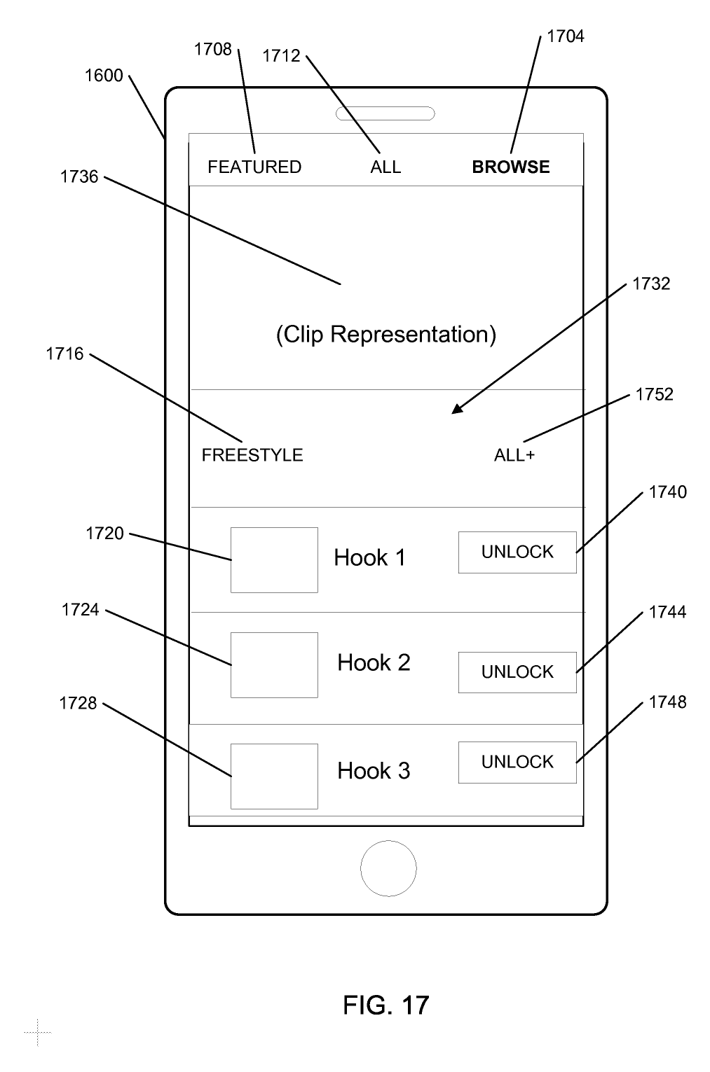

FIG. 17 is a view of the mobile device 1600 on which an embodiment of the application is executing, showing a screen shot of a “Browse” display of the application, noted by the “Browse” display button 1704 toward the top of the FIG. 17 display. The legend of the “Browse” button 1704 is highlighted in FIG. 17 to indicate it has been selected. Other display configurations may be initiated by selecting “Featured” 1708 or “All” 1712 of the FIG. 17 display. The “Browse” display of FIG. 17 implements a left-right scrolling operation for selection of a genre with up-down scrolling for selection of clips or categories within a genre. For example, FIG. 17 shows a “Freestyle” heading 1716 that indicates a genre of “Freestyle” has been selected, with multiple clips or hooks 1720, 1724, 1728 listed below the “Freestyle” heading of the display list area 1732. Above the display list area 1732 is an icon or representation of a selected clip or hook 1736, such as a default selection or featured selection. Swiping the display list of clips up and down moves the display in vertical scrolling, which will be familiar to those skilled in the art. A clip may be selected by selecting the “Unlock” button next to the corresponding clip, indicated by the “Unlock” buttons 1740, 1744, 1748 corresponding to respective clips 1720, 1724, 1728. Additional clips within the displayed genre may be shown by selecting the “All+” button 1752. Swiping the display list area 1732 left and right in the drawing changes the FIG. 17 display to show additional genre types 1716. For example, the genre types may include Pop, Alternative, Dance, Rock, Country, Hip Hop, Holiday, Soul, Latin, and the like (not shown).

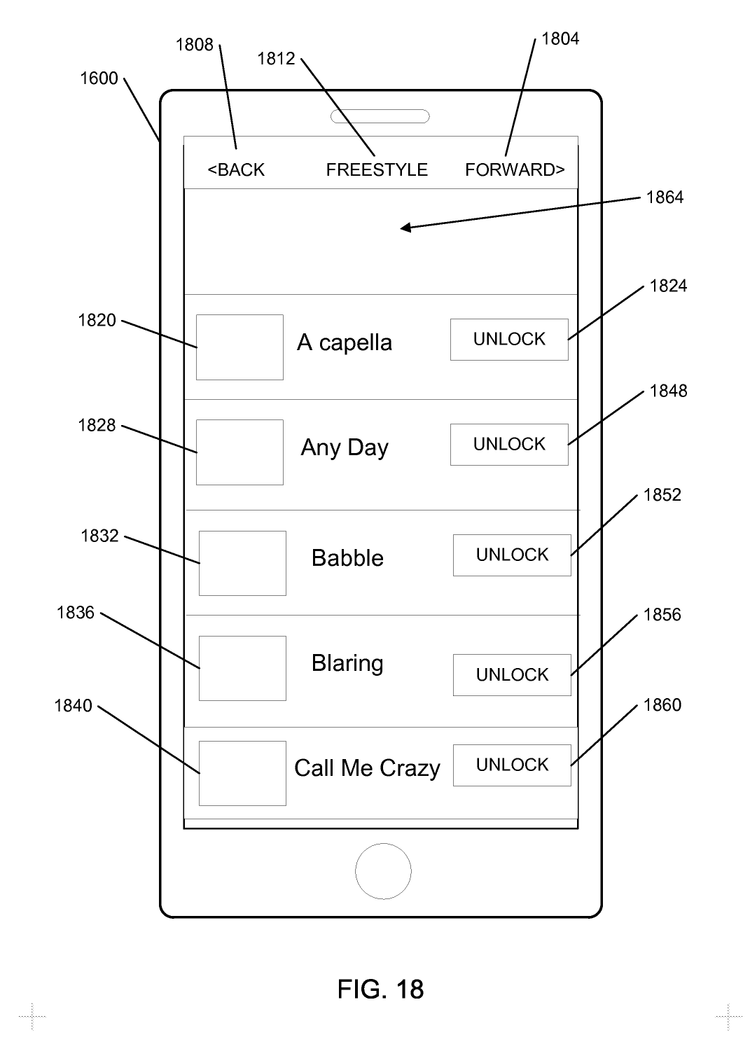

FIG. 18 is a view of the mobile device 1600 on which an embodiment of the application is executing, showing a screen shot of an “All+” list display selected from the FIG. 17 menu. At the top of the display are Forward 1804 and Back 1808 buttons, and a central title button 1812 that indicates The “All” list shows, in an alphabetical list, the feature of an a capella clip 1820, of the genre “Freestyle”, the a capella clip comprising a blank clip. The a capella clip feature may be initiated by selecting the corresponding “Unlock” button 1824. Other clips may be selected, in the alphabetical listing of clips 1828, 1832, 1836, 1840, by selecting corresponding “Unlock” buttons 1848, 1852, 1856, 1860 to initiate clip processing, for which, see the description accompanying FIGS. 3-12 above. A search window 1864 is provided, into which a text string may be inserted for searching a clip library by song title or artist name.

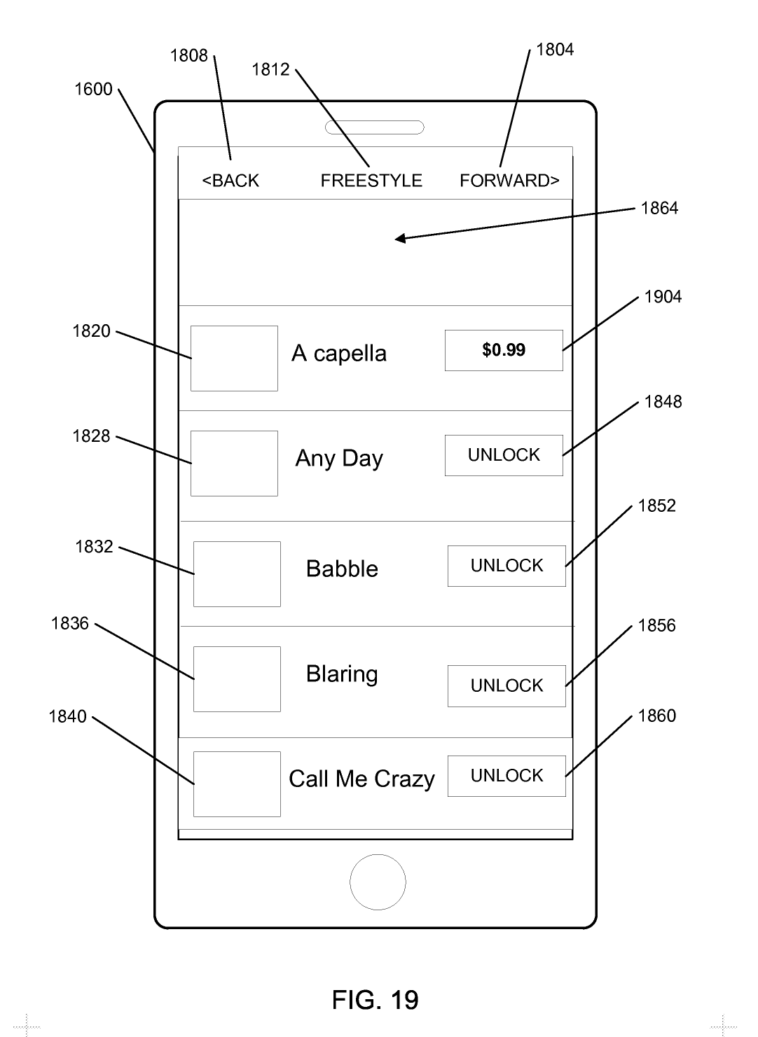

FIG. 19 is a view of the mobile device 1600 on which an embodiment of the application is executing, showing a screen shot of an “A capella” selection from the FIG. 18 menu. Selecting the “Unlock” button 1824 (FIG. 18) changes the display of the button to show a button 1904 with the price for which the clip may be purchased. Processing for the a capella clip, or any other corresponding clip that is selected, generally follows the processing described above, accompanying FIGS. 3-12. After performing and thereby supplying new content, the user may name the new composite clip, and that clip will be available for future recording, listed under the named title, as shown in FIGS. 3-12 above.

It will be appreciated that many additional processing capabilities are possible, according to the description herein. Further, it should be noted that the methods, systems, and devices discussed above are intended merely to be examples. Various embodiments may omit, substitute, or add various procedures or components as appropriate. For instance, it should be appreciated that, in alternative embodiments, the methods may be performed in an order different from that described, and various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. Further, the headings provided herein are intended merely to aid in the clarity of the descriptions of various embodiments, and should not be construed as limiting the scope of the invention or the functionality of any part of the invention. For example, certain methods or components may be implemented as part of other methods or components, even though they are described under different headings.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figures.

What is claimed is:

1. A method of processing data sent over a computer network, the method comprising:
receiving a clip from a first computer device at a second computer device, the clip comprising one or more tracks of clip data configured for playback by a playback application and including at least one synchronization indicator in each of the one or more tracks, to which the tracks may be aligned for synchronized playback;
producing playback of the one or more tracks at an output terminal of the second computer device in response to a playback command;
recording a user performance received through an input terminal of the second computer device in response to a record command and storing the recorded user performance at the second computer device in response to a store command;
generating a combined performance comprising the recorded user performance and at least one of the one or more tracks of clip data, in response to a preview command at the second computer device;
storing the combined performance in response to a store command at the second computer device.

2. The method as in claim 1, the method further including:
sending the combined performance over the computer network in response to a submit command at the second computer device.

3. The method as in claim 1, wherein the sent combined performance is sent over the computer network to a sharing service.

4. The method as in claim 1, further including:
selecting at least one effect process to apply to the user performance prior to generating the combined performance.

5. The method as in claim 4, wherein the effect process comprises a reverberation effect applied to the user performance.

6. The method as in claim 4, wherein the effect process comprises an audio adjustment to the user performance.

7. The method as in claim 6, wherein the audio adjustment comprises a pitch adjustment.

8. The method as in claim 4, wherein the effect process comprises a video adjustment to the user performance.

9. The method as in claim 4, further comprising:
collecting data that identifies effects processes selected from a plurality of computing devices from which the effects processes are applied to the user performances.

10. The method as in claim 1, further comprising:
collecting data that identifies clips selected from a plurality of computing devices from which clips are selected.

11. The method as in claim 1, wherein the user performance includes a video performance.

12. The method as in claim 1, wherein the video performance is recorded at the second computer device.

13. The method as in claim 1, wherein the received clip comprises a blank clip having no content.

14. The method as in claim 1, wherein the first computer device comprises data storage of the second computer.

15. The method as in claim 14, wherein the data storage comprises memory of the second computer.

16. The method as in claim 15, wherein the data storage comprises external memory communicating with the second computer.

17. A method of processing data sent over a computer network, the method comprising:
performing playback of a clip stored at a first computer device such that the playback is produced at an output terminal of a second computer device in response to a playback command, the clip comprising one or more tracks of music data configured for playback by a music application and including at least one synchronization indicator in each of the one or more tracks, to which the tracks may be aligned for synchronized playback;
recording a user performance received through an input terminal of the second computer device in response to a record command and storing the recorded user performance at the second computer device in response to a store command;
generating a combined performance comprising the recorded user performance and at least one of the one or more tracks of music data, in response to a preview command at the second computer device;
storing the combined performance in response to a store command at the second computer device.

18. A device comprising:
a memory;
at least one network interface; and
a processor coupled to the memory and the at least one network interface, wherein the processor performs a method comprising:
receiving a clip from a first computer device at a second computer device, the clip comprising one or more tracks of clip data configured for playback by a playback application and including at least one synchronization indicator in each of the one or more tracks, to which the tracks may be aligned for synchronized playback;
producing playback of the one or more tracks at an output terminal of the second computer device in response to a playback command;
recording a user performance received through an input terminal of the second computer device in response to a record command and storing the recorded user performance at the second computer device in response to a store command;
generating a combined performance comprising the recorded user performance and at least one of the one or more tracks of clip data, in response to a preview command at the second computer device;
storing the combined performance in response to a store command at the second computer device.

19. The device as in claim 18, the method further including:
sending the combined performance over the computer network in response to a submit command at the second computer device.

20. The method as in claim 18, wherein the sent combined performance is sent over the computer network to a sharing service.

21. The method as in claim 18, further including:
selecting at least one effect process to apply to the user performance prior to generating the combined performance.

22. The method as in claim 21, wherein the effect process comprises a reverberation effect applied to the user performance.

23. The method as in claim 21, wherein the effect process comprises an audio adjustment to the user performance.

24. The method as in claim 23, wherein the audio adjustment comprises a pitch adjustment.

25. The method as in claim 21, wherein the effect process comprises a video adjustment to the user performance.

26. The method as in claim 21, further comprising:
collecting data that identifies effects processes selected from a plurality of computing devices from which the effects processes are applied to the user performances.

27. The method as in claim 18, further comprising:
collecting data that identifies clips selected from a plurality of computing devices from which clips are selected.

28. The method as in claim 18, wherein the user performance includes a video performance.

29. The method as in claim 18, wherein the video performance is recorded at the second computer device.

30. The method as in claim 18, wherein the received clip comprises a blank clip having no content.

31. The method as in claim 18, wherein the first computer device comprises data storage of the second computer.

32. The method as in claim 31, wherein the data storage comprises memory of the second computer.

33. The method as in claim 32, wherein the data storage comprises external memory communicating with the second computer.
